(19) United States
(12) Patent Application Publication
(10) Pub. No.: US 2001/0033155 A1
(43) Pub. Date: Oct. 25, 2001

(54) Voltage supply circuit and display device

(75) Inventors: Takaaki Sakurai, Sagamihara-shi (JP); Yoshiteru Watanabe, Kawasaki-shi (JP); Hiroshi Yoshikawa, Sagamihara-shi (JP)

Correspondence Address: Derek S. Jennings, IBM Corporation, Intellectual Property Law Dept., P.O. BOX 218, Yorktown Heights, NY, 10598, US

(73) Assignee: International Business Machines Corporation, Armonk, NY (US)

(21) Appl. No.: 09/816,884

(22) Filed: Mar. 23, 2001

(30) Foreign Application Priority Data
Mar. 23, 2000 (JP) 2000-082939
May 18, 2000 (JP) 2000-146376

(51) Int. Cl. G05F 1/40

(52) U.S. Cl. 323/281

(57) ABSTRACT

A voltage supply circuit includes transistors that are inserted between a plurality of output terminals. Reference voltages, required for respective nodes, are outputted by controlling the conductance of the transistors. Differential amplifier circuits are connected to the transistors, and outputs from the output terminals are inputted to the differential amplifier circuits. The differential amplifier circuits controls the conductance of the transistors based on differences between reference voltages and the outputs of the output terminals. Power to the differential amplifier circuits is supplied from the respective power source circuits, and is provided independently of the outputs from the transistors.

### BACKGROUND OF THE INVENTION

The present invention relates to a voltage supply circuit and a display device, more particularly to a voltage supply circuit, which controls output voltages by controlling transistors connected between a plurality of output terminals, and a display device.

Recent years, liquid crystal display (hereinafter, often referred to as “LCD”) devices have been used in a wide field ranging from a middle/large size display used for such as a computer and a television set to a small size display used for a car navigation system and a cellular phone. Among them, an attention is paid to an active matrix liquid crystal display device using an active device such as a thin film transistor (TFT) and a metal in metal (MIM) liquid crystal for its excellence in a display characteristic. Such an active matrix liquid crystal display device typically has a TFT array substrate, which has TFTs as active devices arranged in a matrix fashion and an opposing substrate facing the TFT array substrate, and between these two substrates, a liquid crystal is sealed.

In a color liquid crystal display device, a color filter for performing a color display is typically provided on an opposing substrate. The liquid crystal display device has a display area constituted of a plurality of subpixel portions, and each subpixel portion has a pixel electrode and a TFT. An electric field is applied to a liquid crystal by the pixel electrode, thus a light transmittance is changed to perform an image display. Each subpixel portion performs a color display of any one of R, G and B, and one pixel portion is formed of three different subpixel portions. In the case of a monochrome display, it is needless to say that the subpixel portion is equivalent to the pixel portion.

Each subpixel portion applies an electric field to the liquid crystal based on a signal voltage inputted from a driver IC. Driver IC is typically connected to a TFT by tape automated bonding (hereinafter referred to as TAB). However, in some cases, the driver IC may be directly provided on a glass substrate of a TFT array. Typically, a plurality of source driver ICs for signal lines are provided on one edge of the TFT array substrate, and a plurality of gate driver ICs for gate lines controlling gate voltages are provided on one other edge thereof. A voltage inputted from the source driver IC applies the electric field to the liquid crystal through source/drain of the TFT. By changing this voltage, the electric field applied to the liquid crystal may be changed to control the transmittance of the liquid crystal.

An input voltage value from the source driver IC to the TFT array is determined based on a control signal from an external circuit and a reference voltage from a reference voltage supply circuit. A function defining a relation between the control signal and the transmittance of the liquid crystal is referred to as a tone curve. In the source driver IC, a plurality of reference voltage input terminals are provided. In addition to these terminals, voltages realizing a desired tone curve are required to be inputted. When viewed from an outside of the driver IC, these terminals of the driver IC constitute both ends of a resistor of a voltage dividing circuit and an intermediate tap thereof. Note that the intermediate tap is an input/output terminal portion between the both ends.

In the prior art, in order to apply a desired voltage to the driver IC, resistors have been connected in parallel one from another to the internal resistor of the driver IC, and desired voltages have been applied to the both ends thereof. A division ratio of the voltage may be changed by changing resistance values of the connected resistors, thus the desired voltages may be applied to the both ends and the intermediate tap of the driver IC. However, since a variation of an internal resistance value is large for each driver IC, even if predetermined resistors are inserted in parallel therein, it has been difficult that a variation of each terminal voltage is suppressed to a small extent. Moreover, since the resistance value is fixed, it has been impossible to cope with a request of changing the voltage applied to the internal resistor of the driver IC.

As a method of solving the foregoing problems, a method of using an active device is conceived for fixing a voltage of the internal resistor, that is, a voltage between the intermediate taps. For example, individual output devices are prepared for the respective both ends and intermediate taps, and the outputs of the respective output devices are connected to the both ends and the intermediate taps as the respective outputs of the voltage supply circuit. In the case where the output devices, the number of which is equivalent to that of necessary outputs, are constituted of individual OP amps, currents that must be outputted to output terminals are supplied from a positive power source of the output devices driving the output terminals. On the other hand, currents that must be sunk from the output terminals to the outside of the driver IC are returned to a negative power source of the output device driving the output terminals. Specifically, the increase of the number of the output terminals results in the increase of the currents that must be supplied to the entire circuit.

Japanese Patent Laid-Open No. Hei 11-160673 discloses a power source circuit for driving a liquid crystal, which is used for the purpose of reducing power consumption in an OP amp. The power source circuit is made by connecting a plurality of OP amps. An output of each OP amp becomes each output of the power source circuit. Each OP amp is formed of a differential amplifier circuit and an output circuit constituted of a pMOS transistor. A bias current from a power source is inputted to a source of the pMOS transistor of a first OP amp, and an output from a drain as an output of the first OP amp is connected to a power source of an OP amp at a downstream thereof. The output from the OP amp at the upper stream is inputted to a power source terminal of the differential amplifier circuit and the output circuit (pMOS transistor) of the OP amp at the downstream. With such a construction, a current used in the OP amp at the upper stream can be used for the OP amp at the downstream, thus the power consumption of the OP amps can be reduced.

However, the conventional circuit as described above cannot fully cope with a request of changing an output voltage by a setting from the outside for realizing a contrast adjustment function, as in a tone curve setting circuit of the liquid crystal display device. Moreover, since each reference voltage is made from one OP-amp, the output voltage is restrained by the rated power of the OP-amp. Thus, a flexible design is not possible.

### SUMMARY OF THE INVENTION

A feature of the present invention includes a voltage supply circuit having transistors that are inserted between a plurality of output terminals. Reference voltages, required for the respective nodes, are outputted by controlling conductance of the transistors. Differential amplifier circuits are connected to the transistors, and outputs from the output terminals are inputted to the differential amplifier circuits. The differential amplifier circuits control the conductance of the transistors based on differences between reference voltages and the outputs of the output terminals. Power to the differential amplifier circuits is supplied from the respective power source circuits, and is provided independently of the outputs from the transistors.

For a more complete understanding of the present invention and the advantages thereof, reference is now made to the following description taken in conjunction with the accompanying drawings.

### BRIEF DESCRIPTION OF THE DRAWINGS

FIG. 1 is a schematic circuit diagram illustrating a voltage supply circuit according to a first embodiment.

FIG. 2 is a schematic circuit diagram illustrating a voltage supply circuit according to a second embodiment.

FIG. 3 is a schematic diagram illustrating a construction of the voltage supply circuit in the liquid crystal display device.

### DETAILED DESCRIPTION OF THE PREFERRED EMBODIMENTS

A feature of the present invention is to obtain a voltage supply circuit and a display device, which are capable of reducing a power consumption of the entire circuit. Another feature of the present invention is to provide a voltage supply circuit and a display device, which are capable of changing an output voltage flexibly. Still another feature of the present invention is to provide a voltage supply circuit and a liquid crystal display device, which are capable of reducing a power consumption of the entire circuit and securing a degree of freedom on design.

In accordance with a feature of the present invention a sink current of an output terminal is reused as a source current to one other terminal (node).

Each of the differential amplifier circuits is preferably includes at least one OP-amp. Moreover, an input from the input terminal to the differential amplifier circuit is inputted from a negative feedback circuit. The input from the output terminal may be inputted directly to the differential amplifier circuit or may be inputted thereto through a resistor. A variable potential input may be connected to the differential amplifier circuit through a resistor. Some of the reference voltages inputted to the respective differential amplifier circuits may be made identical.

A voltage supply circuit can be used as a circuit for a display device, particularly as a voltage supply circuit for setting a tone curve of the display device. The voltage supply circuit supplies a voltage to realize a desired tone curve to the reference voltage input terminal of a driver IC. The variable potential input may be used for realizing a contrast adjustment function. Moreover, a circuit for inputting an identical reference voltage to the differential amplifier circuit may be used for outputting a voltage for performing column inversion display and row inversion display.

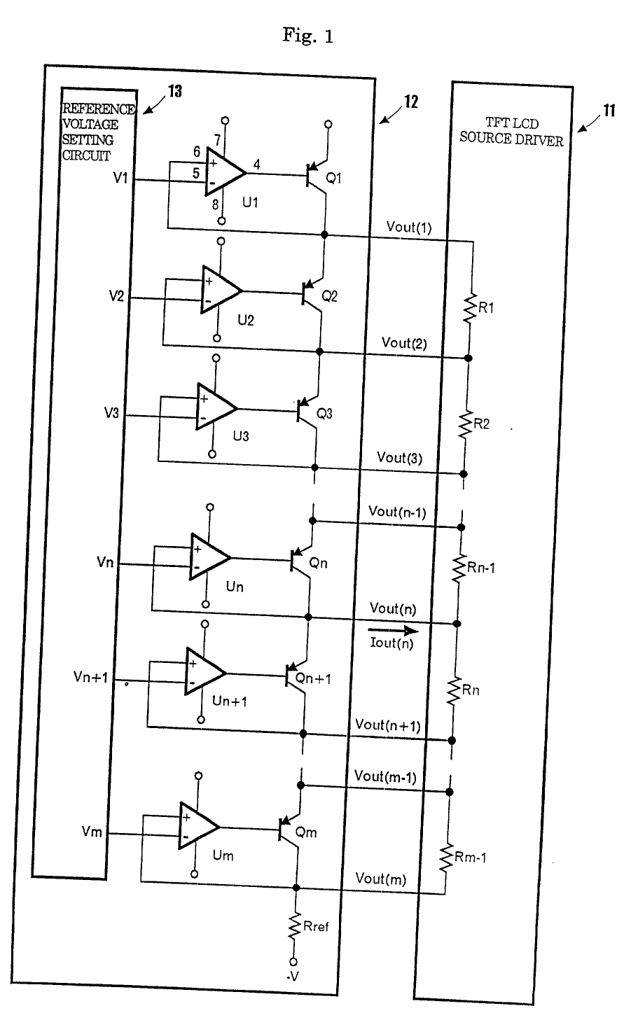

FIG. 1 is a schematic circuit diagram partially illustrating a voltage supply circuit for a TFT source driver according to a first embodiment. The voltage supply circuit is used as a reference voltage source for setting a tone curve of the TFT source driver (function for setting a relation of a transmittance change to a predetermined numerical value (signal)). The voltage supply circuit may be used not only for the liquid crystal display device but also other display devices such as a self-light emitting type display using an active matrix-polymer light emitting diode (AM-PLED) or an active matrix-organic light emitting diode (AM-OLED) and the like.

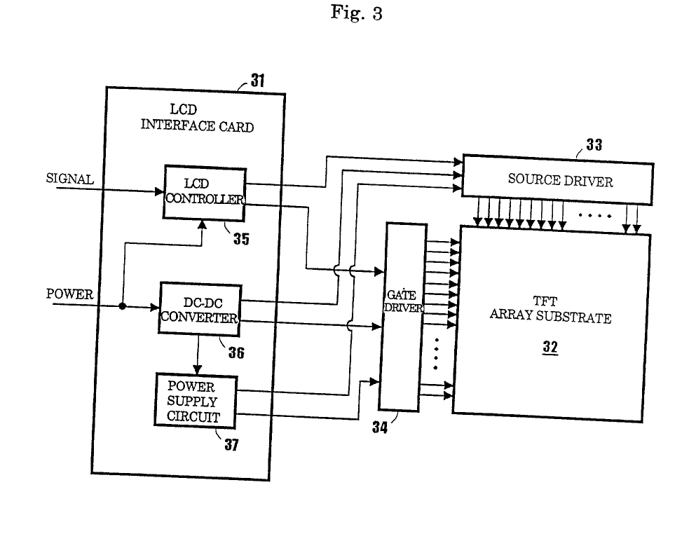

FIG. 3 is a function diagram explaining a function of the voltage supply circuit in the liquid crystal display device. This drawing was made for explaining the function of the voltage supply circuit in the liquid crystal display device, and does not reflect the construction of the actual liquid crystal display device. In the drawing, a reference numeral 31 denotes an LCD interface card, and a numeral 32 denotes a TFT array substrate in which TFTs as active devices are arranged in a matrix fashion thereon. A reference numeral 33 denotes a source driver for controlling a voltage of source electrodes of the TFT array, and reference numeral 34 denotes a TFT gate driver for controlling a voltage of gate electrodes of the TFT array. Reference numeral 35 denotes an LCD controller for controlling the drivers 33 and 34, reference numeral 36 is a DC-DC converter and 37 is a voltage supply circuit. The LCD interface card 31 includes a LCD controller 35, the DC-DC converter 36 and the voltage supply circuit 37.

Besides the above, the liquid crystal display (LCD) device comprises an opposing substrate (not shown) facing the TFT array substrate. In a color LCD device, a color filter is typically provided on the opposing substrate. The LCD has a display area constituted of a plurality of subpixels arranged in a matrix fashion, and each subpixel portion comprises a TFT, a pixel electrode, a color filter and a liquid crystal. An electric field is formed between pixel electrodes provided on the two substrates to control a light transmittance of the liquid crystal, thus performing an image display. One pixel portion is comprised of three subpixel portions of R, G and B. In the case of a monochrome display, the subpixel portion is equivalent to the pixel portion.

Voltages applied to the pixel electrodes are controlled by voltages inputted from the drivers 33 and 34. The drivers 33 and 34 are controlled by input signals from an external circuit. The TFT source driver 33 is comprised of a plurality of driver ICs. These driver ICs are typically connected to the TFT array substrate 32 and the LCD interface card 31 by tape automated bonding (TAB), however, in some cases, the driver ICs may be directly provided on the glass substrate of the TFT array substrate 32. Typically, a plurality of source driver ICs for signal lines are provided on one edge of the TFT array substrate 32, and a plurality of gate driver ICs for gate lines controlling gate voltages are provided on the other edge thereof. Voltages inputted from the source driver ICs apply an electric field to the liquid crystal through the sources/drains of the TFTs and the pixel electrodes. The applied electric field may be changed by changing the input voltages, thus controlling the trasmittance of the liquid crystal.

An input voltage value from the source driver IC to the TFT array substrate 32 is determined based on a signal from the LCD controller 35 and a reference voltage from the voltage supply circuit 37. In each source driver IC, a plurality of reference voltage input terminals are provided. These voltage input terminals receive voltages realizing a desired tone curve from the voltage supply circuit 37. When viewed from an outside of the reference voltage input terminals, these terminals constitute both ends of a voltage dividing circuit having a resistor connected between the terminals and an intermediate tap as an intermediate input terminal. A reference numeral 11 of FIG. 1 is a conceptional circuit diagram illustrating the TFT source driver 33, in which a plurality of resistors are connected in series. The intermediate taps are formed between the respective resistors. In an actual liquid crystal display device, the outputs from the voltage supply circuit are respectively connected to the plurality of driver ICs. For example, the voltage supply circuit 37 has sixteen output terminals, each of which is inputted in parallel to each driver IC through a common wiring.

Again, with reference to FIG. 1, the voltage supply circuit will now be described. A reference numeral 11 denotes a TFT source driver, reference numeral 12 a voltage supply circuit and reference numeral 13 a reference voltage setting circuit. Reference numerals R1 to Rm−1 denote internal resistors in the TFT source driver. Reference numerals Q1 to Qm denote transistors as active devices. In this embodiment, bipolar transistors are used as the transistors. As a matter of course, other type of transistors, such as MOSFETs may be used. Reference numeral U1 to Um denote differential amplifier circuits having a function as computing circuits. In this embodiment, one differential amplifier circuit is made from a single OP-amp. The voltage supply circuit 12 includes the reference voltage setting circuit 13, the differential amplifier circuits Ul to Um and the transistors Q1 to Qm. Each of the differential amplifier circuits Ul to Um has an inverting input terminal 5, a non-inverting input terminal 6, an output terminal 4 and power source terminals 7 and 8.

A collector of the bipolar transistor Q(n) at an upper segment is connected to an emitter of a bipolar transistor Q(n+1) at a lower segment. The emitter and the collector of each transistor Q(n) are connected to nodes for output voltages Vout(n−1) and Vout(n) of the voltage supply circuit. The power is inputted to an emitter of a transistor Q(1) at the uppermost segment, and only a collector thereof is connected to a node for an output voltage Vout(1) of the voltage supply circuit. An output from the collector of the transistor Q(n) is inputted to the non-inverting input terminal 6 of the amplifier U(n), thereby forming a negative feedback circuit.

In other words, the output voltage Vout(n) of the voltage supply circuit is inputted to the non-inverting input terminal 6 of the amplifier U(n). Note that, since the transistor Q(n) having a grounded emitter turns the output into a negative phase, the input to the amplifier U(n) is inputted in a negative phase. Input terminal 5 of the amplifier U(n) receives a reference voltage V(n) from the reference voltage setting circuit 13 and outputs a difference between two inputs. Each power of the amplifiers U is supplied not from the output of the transistor but from positive and negative power sources. The power is supplied from the DC-DC converter 36. The output of the amplifier U(n) is supplied to a base of the transistor Q(n). There may be some cases where the inputting is performed through a resistor for restraining a base current during a malfunction or for other purposes.

The voltage supply circuit 12, in this embodiment, controls an output voltage Vout(1), Vout (2), . . . , and Vout (m), respectively, by changing conductance of the transistors Q. The output voltage Vout(n) is controlled by the circuit at the n-th segment, which has the amplifier U(n) and the transistor Q(n). An internal resistor R(n) of the source driver has its ends connected to the nodes for the output voltages Vout(n) and Vout(n+1), and a voltage (Vout(n)−Vout(n+1)) is applied to the resistor R(n). The output voltages Vout(1) to Vout(m) are outputted to the feedback circuit returning the output voltage to the non-inverting input terminal 6 of the amplifier and the source driver 11.

The differential amplifiers (U(l) to U(m)) compare reference voltages (V1 to Vm) supplied from the reference voltage setting circuit 13 with the output voltages (Vout(1) to Vout(m)) inputted through the feedback circuits. Then, the differential amplifiers U(1) to U(m) control the respective transistors Q(1) to Q(m) by supplying an output from the output terminals 4 so that the reference voltages V1 to Vm and the corresponding output voltages Vout(1) to Vout(m) can have identical potentials. Individually, the differential amplifier U(n) compares the reference voltage V(n) applied from the reference voltage setting circuit 13 with the output voltage Vout(n). Then, the differential amplifier U(n) controls the conductance of the transistor Q(n) by supplying an output from the output terminal 4 so that the voltage V(n) and the output voltage Vout(n) can have an identical potential.

Each segment has an identical sum of the currents flowing in the transistor Q(n) and the internal resistor R(n−1) of the source driver 11. The sum of the current is determined with V(m)−(−V) and Rref. Concretely, the total current of each segment is represented as (V(m)−(−V)/Rref). Herein, Rref is a resistor connected to the output of the transistor Q(m) at the final segment and the negative power source terminal. It is required that said sum of the current is set to be equal or larger than the largest current value of the currents that must be made to flow in the respective segments of the internal resistors of the source driver 11.

Operation of the current embodiment will be described below. In the case where the output voltage Vout(n) becomes higher than the reference voltage Vn, the output voltage of the differential amplifier Un rises. Thus, the base current of the transistor Qn is reduced, resulting in a reduction of the collector current of the transistor Qn. Since the sum of the currents flowing in the transistor Qn and the load resistor Rn−1, which are located at each segment, is kept at a constant value (V(m)/Rref) determined with the value of the reference voltage V(m) and the resistance value of the resistor Rref, the current flowing in the load resistor Rn−1 is increased for a reduced amount of the collector current of the transistor Qn. The current flowing in the resistor Rn−1 is increased, thus the voltages at both ends of the resistor Rn−1 are increased. Since the node for the output voltage Vout(n−1) is kept at a constant voltage by the circuit located at the above segment thereof, the output voltage Vout(n) is lowered.

On the contrary to the above, in the case where the output voltage Vout(n) becomes lower than the reference voltage Vn, the output voltage of the differential amplifier Un is lowered. Thus, the base current of the transistor Qn is made to be increased, and as a result, the collector current of the transistor Qn is made to be increased. Since the sum of the currents flowing in the transistor Qn and the load resistor Rn−1, which are located at each segment, is kept at a constant value, the current flowing in the resistor Rn−1 is reduced for an increased amount of the collector current of the transistor Qn. Consequently, the voltages at the both ends of the resistor Rn−1 are reduced. Since the node for the output voltage Vout(n−1) is kept at a constant voltage by the circuit located at the above segment thereof, the output voltage Vout(n) is increased. Thus, the output voltage Vout(n) is kept constant with the reference voltage Vn as a target voltage.

As can be understood from the above-described operation, in order to raise the voltage of output node Vout(n), the output current Iout(n) from the output node to the source driver is required to be increased. On the other hand, in order to lower the voltage of output node Vout(n), it is required that the output current Iout(n) from the output node to the source driver is decreased or that the output current Iout(n) is sunk from the source driver to the output node. Herein, the current outputted from the inside of the voltage supply circuit to the output node is referred to as a source current, and the current inputted from the source driver to the output node is referred to as a sink current. Note that, in the case where the output current Iout(n) is either positive or negative, the current sunk to the output node is a negative output current.

The amplifiers are directly connected to the respective output nodes, all of the source currents are supplied from the positive power sources to the respective amplifiers and all of the sink currents are returned to the negative power sources of the respective amplifiers. On the other hand, in the method of the present invention, as the source current to the node for the output voltage Vout(n), the sink current from the node for the output voltage Vout(2) to the node for the output voltage Vout(n−1) can be used. On the contrary, the sink current to the node for the output voltage Vout(n) can be used as the source current from the node for the output voltage Vout(n+1) to the node for the output voltage Vout(m−1). Specifically, in place of using the individual power source circuits for the respective voltage output terminals, the circuit constitution is adopted such that control devices such as transistors are arranged between adjacent output terminals. With such a constitution of a circuit, a sink current at a certain output terminal can be used as a source current at an output terminal having a potential lower than that of the concerned terminal. Thus, the power consumption of the entire circuit can be reduced.

In this embodiment, the construction is adopted in which the power for the differential amplifier segments is supplied from the positive and negative power sources of the entire circuit. Thus, the differential amplifier segments can be made of various ICs mounting multicircuits. When the voltage at the output terminal located at the other differential amplifier segment is used as a power of the concerned differential amplifier segment, a range of the power source voltage of the differential amplifier segment is narrowed to narrow a range of the input voltage to the differential amplifier segment. However, in the voltage supply circuit of this embodiment, since the power source of the differential amplifier segment is provided so that the output terminals may not supply the power to the differential amplifier, the voltage supply circuit can cope with the case where the input to the differential amplifier U(n) is not inputted between the output voltages Vout(n) and Vout(n+1). Thus, a degree of freedom on circuit design can be secured.

Note that, in this embodiment, each output segment is made of an emitter-grounded amplifier circuit using the bipolar transistor. However, a collector-grounded amplifier circuit can be adopted. Moreover, in FIG. 1, the resistor Rref determining the sum of the currents flowing in the load resistors in parallel with the transistors at the respective segments is inserted between the lowest output voltage Vout(m) and the negative power source −V. However, the position of the resistor Rref may be optionally selected as long as the transistors or the load resistors are not connected in parallel and the position is located between two points having known voltages. The foregoing description has been made under the assumption that the emitter current of each transistor is equal to the collector current thereof because the base current thereof is sufficiently small in comparison with the collector current or the emitter current.

It is conceived that the output segment is made into an emitter follower (source follower) type to allow the transistor itself to perform the differential amplifier function and the feedback function. Concretely, the collector of the transistor is connected to the other voltage output terminal, and the emitter is set to be the output terminal. Subsequently, a voltage higher than the target voltage by the forward directional base-emitter voltage is previously applied to the base by the resistance division circuit and the like. In such a construction, if the transistor having a sufficiently high amplification ratio is used, the emitter voltage works as a voltage follower outputting a voltage lower than the base voltage by the forward directional base-emitter voltage. Thus, the transistor can be replaced with a combination of the OP amp and the transistor in the manner shown in FIG. 1.

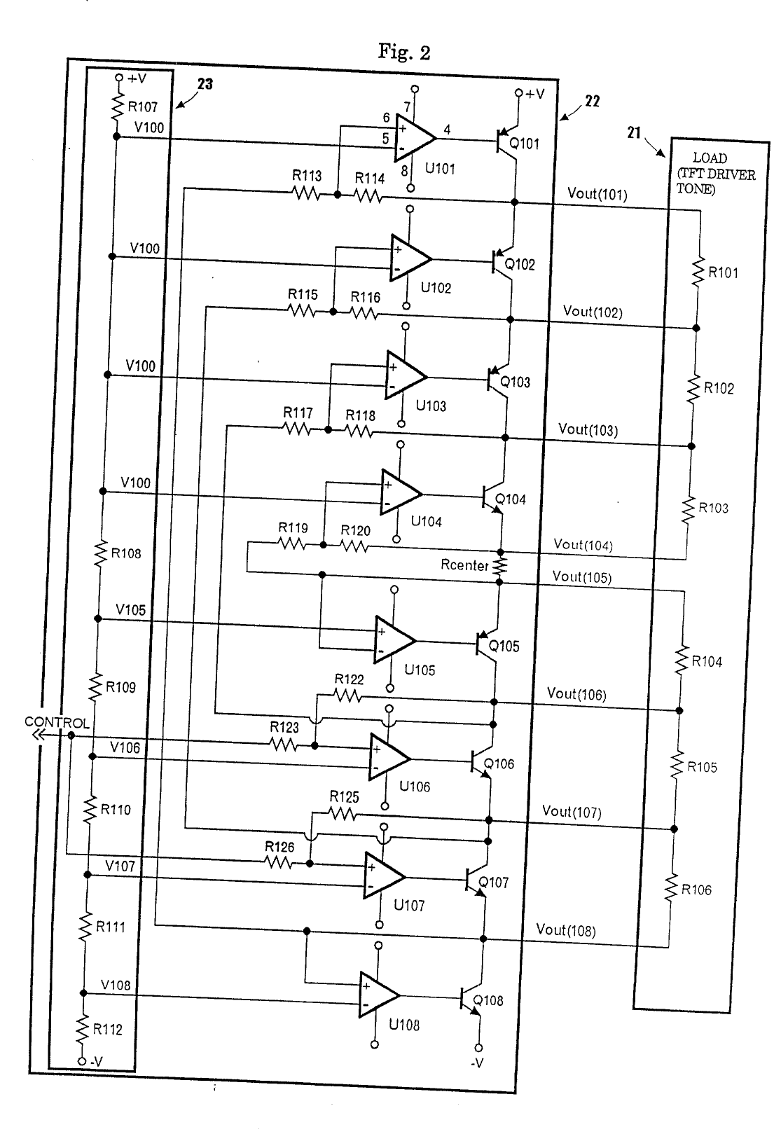

Referring to FIG. 2, shown is a schematic circuit diagram illustrating the reference voltage supply circuit for the TFT source driver according to a second embodiment of the present invention. The reference voltage supply circuit incorporates a resistance dividing circuit, which is symmetrical in the vertical direction, for outputting positive and negative signals. Eight reference voltage input terminals of the driver are provided: four are for voltages for writing the upper portion; and the other four are for voltages for writing the lower portion.

In the drawing, a reference numeral 21 denotes a TFT source driver, a numeral 22 a voltage supply circuit, and a numeral 23 a reference voltage setting circuit in the voltage supply circuit 22. The reference voltage setting circuit 23 comprises a power source and a plurality of resistors connected in series. Predetermined reference voltages are applied to amplifiers by providing output nodes between the resistors. In the TFT source driver 21, R(101) to R(103) denote resistors constituting a positive resistance dividing circuit for outputting positive signals, and R(104) to R(106) denote resistors constituting a negative resistance dividing circuit for outputting negative signals. In the voltage supply circuit 22, Q(101) to Q(104) denote transistors connected between the output nodes of the positive resistance dividing circuit, and Q(105) to Q(108) denote transistors connected between the output nodes of the negative resistance dividing circuit. In this embodiment, bipolar transistors are used. The transistors Q(104) and Q(105) constitute a collector-grounded circuit, and other transistors constitute an emitter-grounded circuit.

Reference numerals Vout(101) to Vout(108) denote voltages outputted from output nodes of the voltage supply circuit 22. Reference numerals U(101) to U(108) denote differential amplifiers for controlling conductance of the respective transistors Q(101) to Q(108), each of which constitutes one OP-amp. The output of the differential amplifier U(n) is inputted to the base of the transistor Q(n). The output Vout(n) of the voltage supply circuit is inputted to the input terminal of the differential amplifier U(n) through the resistor or directly. In such a manner, a negative feedback circuit is made. To another input terminal of the differential amplifier U(n), the reference voltage is inputted from the reference voltage setting circuit 23. To one of the input terminals of each of the differential amplifiers U(106) and U(107), a terminal for control voltage input CONTROL from the outside is connected through the resistors. Positive inputs of the differential amplifiers U(106) and U(107) are connected to the output nodes through the resistors. A power for each amplifier U is supplied not from the output from the transistor but from a positive power source +V and a negative power source −V of the entire circuit. The output of the differential amplifier U(n) is inputted to the base of the transistor Q(n). There may be some cases where the output of the amplifier U(n) is inputted to the base of the transistor Q(n) through the resistor.

Continuing with the description of the circuit, segment 101 has the differential amplifier U(101), the transistor Q(101), the resistors R(113) and R(114). The resistance values of the resistors R(113) and R(114) are identical. The collector of the transistor Q(101) is directly connected to the node for the output voltage Vout(101). And the output of the collector of the transistor Q(101) is inputted to the non-inverting input terminal 6 of the differential amplifier U(101) through the resistor R(114). In other words, the output voltage Vout(101) is inputted to the non-inverting input terminal 6 of the differential amplifier U(101) through the resistor R(114). To the inverting input terminal 5 of the differential amplifier U(101), a voltage of V100 is inputted from the reference voltage setting circuit 23. The non-inverting input terminal 6 is connected to the ends of the resistors R(113) and R(114). The other end of the resistor R(113) is connected to the node for the output voltage Vout(108). The other end of the resistor R(114) is connected to the node for the output voltage Vout(101). The collector of the transistor Q(101) and the emitter of the transistor Q(102) are directly connected.

The circuits of the segments 102 and 103 are constructed in a similar manner to the circuit of the segment 101, and the description thereof will be omitted. Moreover, the circuit of the segment 104 is different from the circuit of the segment 101 only in the connection of the transistor. In the segments 101 to 104, the reference input voltage to the amplifiers is V100, which is identical as for these segments 101 to 104. The transistor Q(104) of the segment 104 has the grounded collector. The voltage of the emitter of the transistor Q(104) is inputted to the inverting input terminal 5 of the differential amplifier U(104) through the resistor R(120). Specifically, the output voltage Vout(104) of the segment 104 is inputted to the inverting input terminal 5 of the differential amplifier U(104) through the resistor (120). Note that the resistance values of the respective resistors have the following relations: R(113)=R(114), R(115)=R(116), R(117)=R(118) and R(119)=R(120).

The segment 105 has the differential amplifier U(105) and the transistor Q(105). The emitter of the transistor Q(105) is directly connected to the node for the output voltage Vout(105) and the inverting output terminal 5 of the differential amplifier U(105). To the non-inverting input terminal 6 of the differential amplifier U(105), the reference voltage V105 is inputted from the reference voltage setting circuit 23. The segment 106 has the differential amplifier U(106), the transistor Q(106) and the resistors R(122) and R(123). The collector of the transistor Q(106) is directly connected to the node for the output voltage Vout(106). The collector of the transistor Q(106) and the non-inverting input terminal 6 of the differential amplifier U(106) are connected to each other through the resistor R(122). To the non-inverting input terminal 6 of the differential amplifier U(106), the terminal for the control voltage input CONTROL from the outside is connected through the resistor R(123). To the inverting input terminal 5 of the differential amplifier U(106), the reference voltage V106 is inputted from the reference voltage setting circuit 23.

The non-inverting input terminal 6 of the differential amplifier U(106) is connected to the terminal for the control voltage input CONTROL through the resistor R(123). Thus, the circuit of this segment 106 is made as a computing unit for turning the output voltage Vout(106) into the function of the control voltage input. Specifically, the output voltage Vout(106) is determined as the function of the control voltage input CONTROL and the reference voltage V106. The terminal for the external control voltage input CONTROL can be used changing the tone curve, such as a contrast adjustment function. Segment 107 has a similar design to that of the segment 106, and the description thereof will be omitted. Segment 108 includes the differential amplifier U(108) and the transistor Q(108). The collector of the transistor Q(108) is directly connected to the non-inverting input terminal of the differential amplifier U(108). The node for the output voltage Vout(108) is directly connected to the non-inverting input terminal of the differential amplifier U(108). To the inverting input terminal, the reference voltage V108 from the reference voltage setting circuit 23 is inputted.

The nodes for the output voltages Vout(101) and Vout(108) are connected to each other through the resistors R(113) and R(114). The nodes for the output voltages Vout(102) and Vout(107) are connected to each other through the resistors R(116) and R(115). The nodes for the output voltages Vout(103) and Vout(106) are connected to each other through the resistors R(118) and R(117). The nodes for the output voltages Vout(104) and Vout(105) are connected to each other through the resistors R(120) and R(119). Between the node for the lowest output voltage of the upper half of the resistance dividing circuit and the node for the highest output voltage Vout(105) of the lower half of the resistance dividing circuit, the resistor Rcenter determining the current value is inserted.

The output voltage Vout(105) is generated in a voltage follower circuit constituted of the differential amplifier U(105) and the transistor Q(105). The output voltage Vout(108) is generated in a voltage follower circuit constituted of the differential amplifier U(108) and the transistor Q(108). The target voltages of V105 and V108 are determined by a voltage dividing circuit constituted of the resistors R(107) to R(112). The output voltage Vout(106) is generated in a circuit having the differential amplifier U(106) and the transistor Q(106), and the output voltage Vout(107) is generated in a circuit having the differential amplifier U(107) and the transistor Q(107). The output voltage Vout(106) obtains a linear function between the fixed reference voltage V106 and the control voltage input CONTROL from the outside. The output voltage Vout(107) obtains a linear function between the fixed reference voltage V107 and the control voltage input CONTROL from the outside. Accordingly, the output voltages Vout(101), Vout(102), Vout(103) and Vout(104) obtain symmetrical voltages to the output voltages Vout(108), Vout(107), Vout(106) and Vout(105) with the reference voltage V100 as a center, respectively. Specifically, the circuits of the segments 101 to 104 constitute a voltage inversion circuit with the reference voltage V100 as a center.

The voltage supply circuit 22 of this embodiment controls the respective output voltages Vout(101) to Vout(108) by changing the conductance of the transistors Q(101) to Q(108). Each differential amplifier outputs the output voltage based on a difference between two input voltages, thus the conductance of each transistor is controlled. The operation of controlling the output voltages Vout by controlling the conductance of the transistor constituting the output device of each segment has been described in the Embodiment 1, and the detailed description thereof will be omitted.

In another method of the present invention, as the source current to the node for the output voltage Vout(n), the sink current to the node located at the segment immediately above the concerned segment can be used. On the contrary, the sink current to the node for the output voltage Vout(n) can be used as the source current to the node located at the segment immediately below the concerned segment. Specifically, in place of using the individual power source circuits for the respective voltage output terminals, the circuit construction is adopted such that control devices such as transistors are arranged between adjacent output terminals. With such a construction, the sink current at a certain output terminal can be used as a source current at the output terminal having a potential lower than that of the concerned terminal. Thus, the power consumption of the entire circuit can be reduced. When the voltage at the output terminal located at the other differential amplifier segment is used as a power of the concerned differential amplifier segment, the range of the power source voltage of the differential amplifier segment is narrowed to narrow the range of the input voltage to the differential amplifier segment. For example, as is in this embodiment, the voltage inversion circuit cannot be constituted of the plurality of output voltages with the identical voltage as a reference. However, in the voltage supply circuit of this embodiment, since the power source of the differential amplifier segment is provided so that the output terminals may not supply the power to the differential amplifier, it is possible to constitute the voltage inversion circuit of this embodiment. Moreover, also in the case where the external control voltage input CONTROL is inputted to the circuit of a certain segment, the voltage supply circuit can cope with a necessary change of the input voltage.

The transistors used in the present invention are not limited to the bipolar transistor. Other types of transistors such as an FET can be used. The amplifier may be made using not only an OP-amp but also using a plurality of individual circuit devices. The foregoing description has been made under the assumption that the emitter current of each transistor is equal to the collector current thereof because the base current thereof is sufficiently small in comparison with the collector current and the emitter current.

Although the preferred embodiments of the present invention have been described in detail, it should be understood that various changes, substitutions and alternations can be made therein without departing from spirit and scope of the inventions as defined by the appended claims.

What is claimed is:

1. A voltage supply circuit, which has a plurality of output terminals respectively outputting voltages supplied thereto at predetermined levels, comprising:
transistors connected between said plurality of output terminals; and
a plurality of differential amplifier circuits, each of which operates by receiving power inputted respectively thereto from a power source circuit and performs outputting based on a difference between two inputs,
wherein the outputs from said differential amplifier circuits are inputted to said transistors,
the outputs from said output terminals are inputted to first input terminals of said differential amplifier circuits,
reference voltages are inputted to second input terminals of said differential amplifier circuits,
conductance of said transistors is controlled by the outputs from said differential amplifier circuits, and
output voltages of said output terminals are controlled by controlling the conductance of said transistors.

2. The voltage supply circuit according to claim 1, wherein a variable potential input is connected to at least one of said plurality of differential amplifier circuits.

3. The voltage supply circuit according to claim 1, wherein each of said plurality of differential amplifier circuits comprises at least of one OP-amp.

4. The voltage supply circuit according to claim 1, wherein the outputs of said output terminals are inputted through resistors to said differential amplifier circuits.

5. The voltage supply circuit according to claim 1, wherein reference voltages having identical potentials are inputted to at least two or more of said plurality of differential amplifier circuits.

6. The voltage supply circuit according to claim 2, wherein each of said plurality of differential amplifier circuits comprises at least of one OP amp.

7. A display device, which performs an image display according to a control signal from a driver IC, comprising:
a voltage supply circuit for supplying a reference voltage to said driver IC,
wherein said voltage supply circuit comprises:
a plurality of output terminals respectively
outputting voltages supplied thereto at predetermined levels,
transistors connected between said plurality of output terminals; and
a plurality of differential amplifier circuits, in which outputs thereof are respectively connected to said transistors, and each of which operates by receiving power inputted respectively thereto from a power source circuit and performs outputting based on a difference between two inputs, and
the outputs from said output terminals are inputted to first input terminals of said differential amplifier circuits,
reference voltages are inputted to second input terminals of said differential amplifier circuits,
conductance of said transistors is controlled by the outputs from said differential amplifier circuits, and
output voltages of said output terminals are controlled by controlling the conductance of said transistors.

8. The display device according to claim 7, wherein a variable potential input is connected to at least one of said plurality of differential amplifier circuits, and a tone curve is determined based on said variable potential input.

9. The display device according to claim 7, wherein each of said plurality of differential amplifier circuits comprises at least of one OP-amp.

10. The display device according to claim 7, wherein said driver IC performs a gray tone display based on a gray tone curve determined based on a voltage supplied from said voltage supply circuit.

11. The display device according to claim 7, wherein reference voltages having identical potentials are inputted to at least two or more of said plurality of differential amplifier circuits.

12. The display device according to claim 8, wherein each of said plurality of differential amplifier circuits comprises at least of one OP-amp.
